(19) United States
(12) Patent Application Publication
(10) Pub. No.: US 2018/0264765 A1
(43) Pub. Date: Sep. 20, 2018

(54) PRESS AND METHOD FOR MOLDING AN INGOT MADE OF THERMOPLASTIC OR THERMOSETTING MATERIAL

(71) Applicant: PERSICO S.p.A., Nembro (IT)

(72) Inventor: Paolo AMBROSINI, Nembro (IT)

(21) Appl. No.: 15/542,598

(22) PCT Filed: Dec. 15, 2015
(86) PCT No.: PCT/IT2015/000311

§ 371 Date: Jul. 10, 2017

(30) Foreign Application Priority Data
Jan. 8, 2015 (IT) TO2015A000008

(51) Int. Cl. B30B 15/24; B29C 43/58; B29C 43/02; B30B 1/32; B30B 15/00

(52) U.S. Cl. CPC B30B 15/245; B29C 43/58; B29C 43/02; B29C 2043/3283; B30B 15/007; B29C 2043/5833; B30B 1/323

(57) ABSTRACT

A press (1) is described, for molding an ingot made of thermoplastic or thermosetting material, comprising a basement (10) integral with risers (20), a first and a second plane (30, 40) relatively sliding with respect to the risers (20), by means of first and second hydraulic cylinders (50, 60), respectively adapted to allow opening and closing a mold formed of a first half-mold fastened to the first plane (30) and a second half-mold fastened to the second plane (40), comprising actuators (70) adapted to exert a force whose direction is equal to or opposite with respect to the direction of the force adapted to allow opening or closing the mold; the first plane (30) connected to the basement (10) is moved by means of the first hydraulic cylinders (50) and of the actuators (70), while the second plane (40) is blocked by means of a blocking apparatus (80).

This application is a national stage entry under 37 CFR § 371 of PCT application PCT/IT2015/000311 and claims the benefit of Italian patent application No. TO2015A000008, filed Jan. 8, 2015, which is hereby incorporated by reference in its entirety.

### FIELD OF THE INVENTION

A press for molding an ingot made of thermoplastic or thermosetting material and a related method for molding such ingot. In particular, a system of actuators controlled depending on the parallelism between the relatively moving planes of an hydraulic press, of the vertical type, to mold components made of thermoplastic, thermosetting material.

### BACKGROUND

In general, a vertical hydraulic press comprises a pair of planes, an upper and a lower one, relatively moving, to be able to squash an ingot made of pre-heated or heated, thermosetting or thermoplastic material, through a mold placed on the lower plane.

When forming by compression the ingot made of Thermosetting or thermoplastic material, the mold remains closed. A molding process for composite thermosetting or thermoplastic material can comprise the following steps:

placing an ingot made of material to be molded on a lower half-mold fastened to the lower plane of the press; quickly approaching the lower plane with respect to the upper plane having an upper half-mold, till a related height to get the ingot of material to be molded, slowly compressing till closing the mold formed of the two upper and lower half-molds to be able to transformer such ingot into a product of molded material; keeping the product of molded material inside the closed mold; opening the mold and quickly moving away the mobile plane.

A molding process for products made of composite thermoplastic or thermosetting material occurs by means of vertical presses weighing many tons, with a mobile plane capable of performing wide excursions to allow discharging the molded product. These vertical presses suffer the load concentration transmitted by an ingot-shaped product, whose sizes are of the same order of magnitude along the three Cartesian axes. Squashing and stretching an ingot during the slow mold closure occur due to the slow sliding of the thermosetting or thermoplastic material in the recess inside the mold, till the recess itself is completely filled in.

A problem is known regarding the misalignment of the press planes during the slow compression till the complete mold closure. Such disalignment is caused by the concentration of the load transmitted by the ingot made of composite thermoplastic or thermosetting material on a portion of surface offset with respect to the geometric center of the mold. The non-parallel arrangement of the relatively moving planes implies the wear of the vertical risers and the wear of components sliding along respective mechanical seats, with the danger of seizure and instability phenomena occurring for moving parts.

A vertical hydraulic press operates by means of at least one hydraulic cylinder connected to an hydraulic circuit and actuated by at least one electropump with variable flow-rate. The hydraulic cylinder transmits a force through oil pressing against the cylinder walls and against a piston connected or integral with the mobile plane. Preferably, the step of returning the mobile plane and of opening the mold occurs by means of suitable auxiliary hydraulic cylinders houses in the press framework.

Previous attempts deal with keeping the parallelism during the steps of mold closing, slowly compressing and slowly sliding the mobile plane and is represented by a device comprising a series of hydraulic cylinders arranged on the four sides of the fixed plane and respective position and load sensors connected to a controller. Such controller allows returning a value, equal to the difference between a sample height and the height detected by means of each position sensor. A pump sends pressurized oil towards each hydraulic cylinder of the system for keeping the parallelism of the vertical press planes by means of proportional valves adjusted depending on the measured difference between the sample height and the height detected by the respective position sensor.

IT-A-1240622 discloses a process for controlling a press for producing shaped elements obtained from masses from compression molding with quick reaction. During a pressing cycle, the contrasting cylinders on four angles for regulating the parallelism are controlled in order to provide 15% of the gross compression force.

IT-A-1240622, however, does not solve the problem depending on the contrasting force of the four cylinders, necessary to be able to adjust the parallelism of the two planes. In fact, such force operates oppositely, with respect to the gross compression force, in the balance of forces acting along the relative movement of the press planes implying a reduction of the available net compression force.

U.S. Pat. No. 4,076,780 discloses a compression molding operation controlled by applying a pressing force to a mold having a recess occupied by an ingot made of composite material. The half-mold separation is measured at every press angle by variable linear differential transformers. The hydraulic cylinders operating on the ram, generally in the area of every press angle, are controlled individually to be able to locally change the force pressing onto the planes and keep the two half-molds parallel. Through a controller, the closing speed is controlled according to a pre-configured speed profile and the force pressing onto the mold according to a value programmed during the polymerizing of the molding compound.

U.S. Pat. No. 4,076,780, however, does not disclose the fact of being able to change the force acting onto the mold to allow keeping the parallelism of the two planes.

EP-A-0 492 300 and WO-A-93 05 954 deal with presses according to the preamble of claim 1.

### SUMMARY

An object of some embodiments of the present invention is solving the above problems, by providing a system of actuators controlled depending on the parallelism between the relatively moving planes of a hydraulic press.

A further object is making a system of actuators capable of controlling the parallelism between the relatively moving planes by energetically contributing to the mold compression.

It will be immediately obvious that numerous variations and modifications (for example related to shape, sizes, arrangements and parts with equivalent functionality) can be made to what is described, without departing from the scope of the invention as appears from the enclosed claims.

### BRIEF DESCRIPTION OF THE DRAWINGS

Some embodiments of the present invention will be better described by some preferred embodiments thereof, provided as a non-limiting example, with reference to the enclosed drawings, in which:

FIG. 1 shows an axonometric view of an embodiment of the press for molding an ingot made of thermoplastic or thermosetting material, according to the present invention;

FIG. 2 shows a side view of the press of FIG. 1;

FIG. 3 shows a sectional view along line of FIG. 2;

FIG. 4 shows an enlarged view of portion IV of FIG. 3;

FIG. 5 shows a front view of the press of FIG. 1;

FIG. 6 shows a sectional view along line VI-VI of FIG. 5;

FIG. 7 shows an enlarged view of portion VII of FIG. 6;

FIG. 8 shows a front view of the press of FIG. 1;

FIG. 9 shows a sectional view along line IX-IX of FIG. 8; and

FIG. 10 shows an enlarged view of portion X of FIG. 9.

### DETAILED DESCRIPTION OF EMBODIMENTS

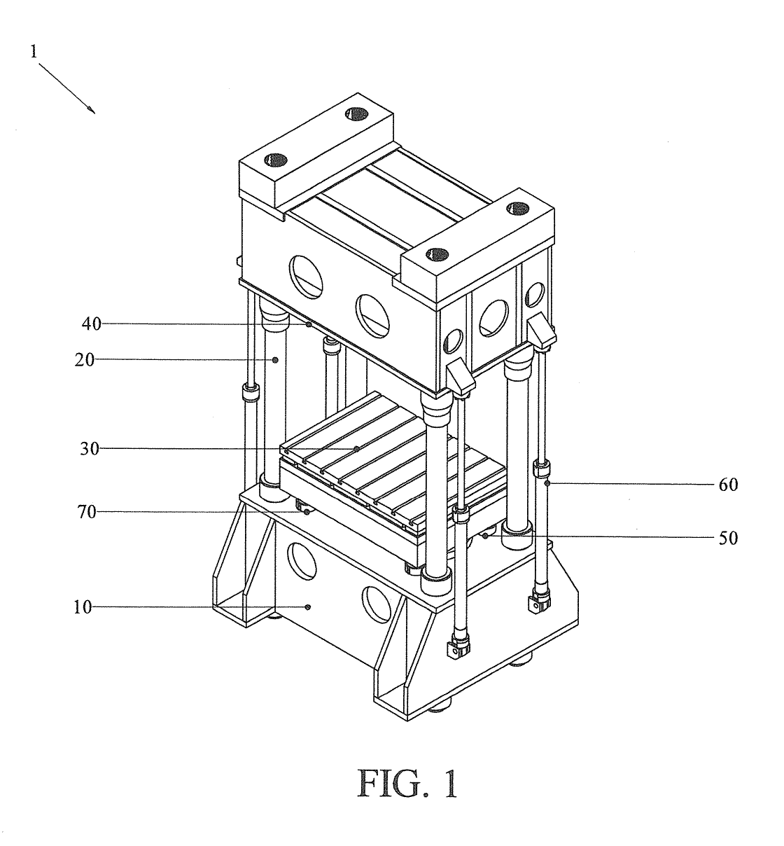

With reference to FIG. 1, it is possible to note that a press 1 for molding an ingot made of thermoplastic or thermosetting material comprises a basement 10 integral with risers 20, a first and a second plane 30, 40 relatively sliding with respect to the risers 20.

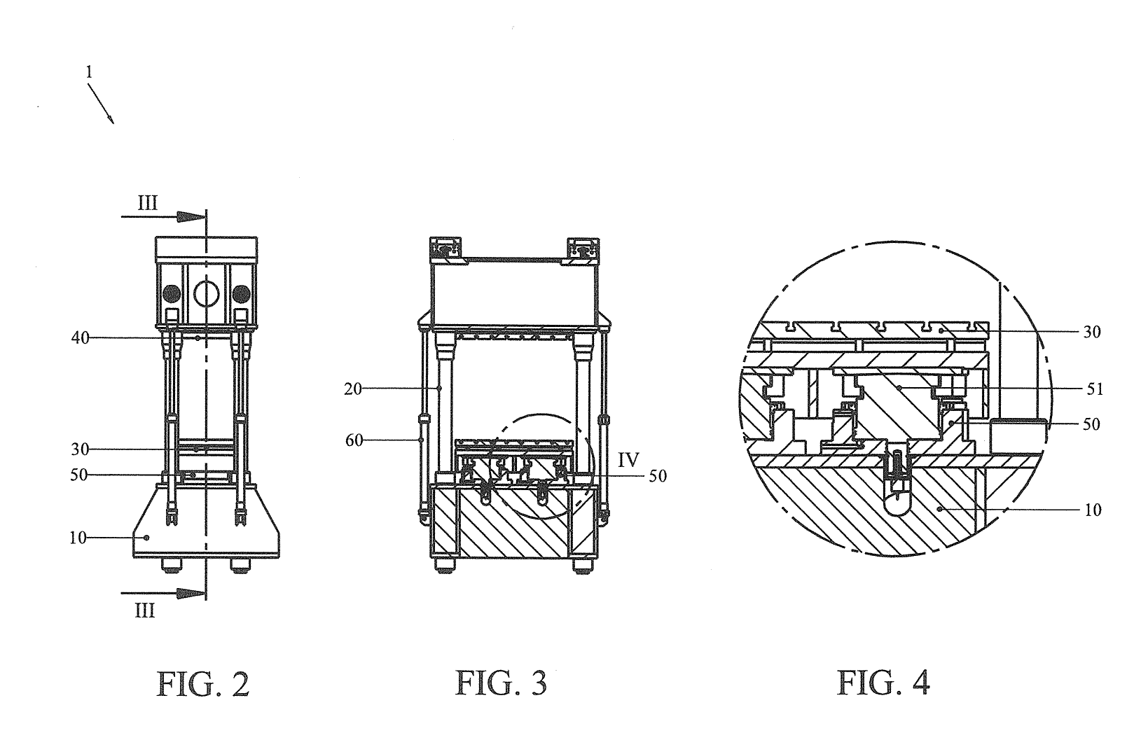

With reference to FIGS. 2, 3, 4, first and second hydraulic cylinders 50, 60, respectively allow opening and closing a mold formed of at least one first half-mold fastened to the first plane 30 and possibly a second half-mold fastened to the second plane 40 and quickly increasing or reducing the relative distance between the first and the second plane 30, 40.

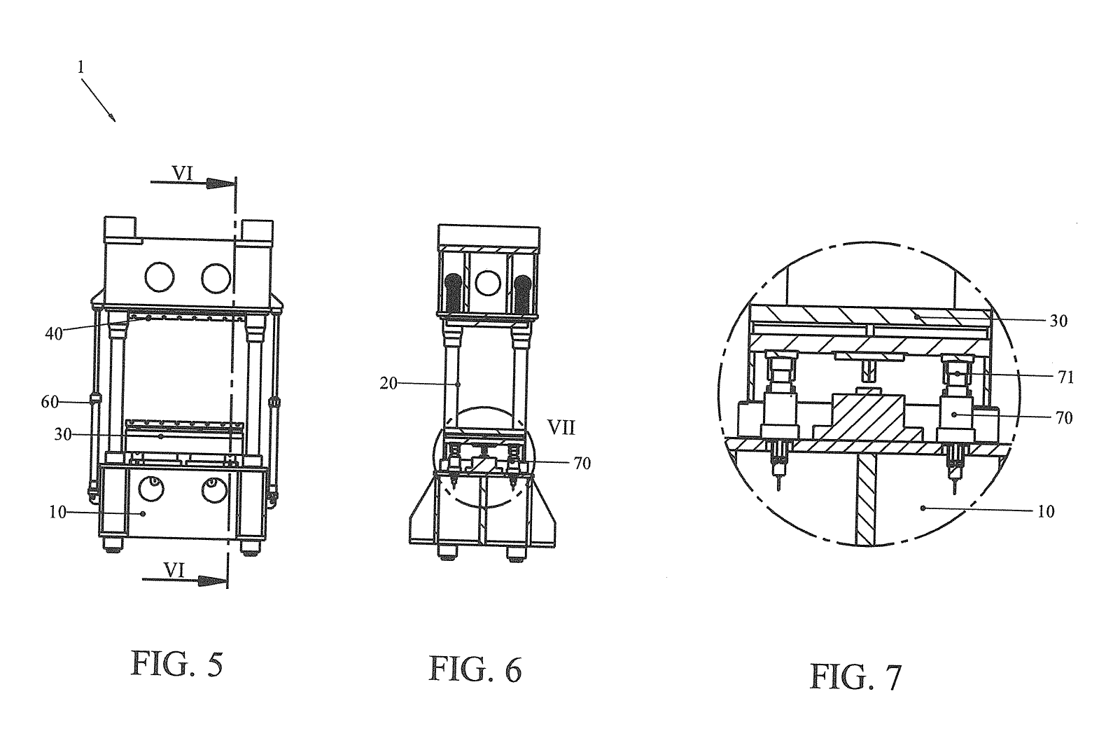

With reference to FIGS. 5, 6, 7, actuators 70 allow containing within a restricted tolerance threshold the parallelism between the first and the second plane 30, 40.

The actuators 70 allow exerting a force whose direction is equal to or opposite with respect to the direction of the force adapted to allow opening or closing the mold.

The first plane 30 connected to the basement 10 is moved by means of the first hydraulic cylinders 50 of the actuators 70.

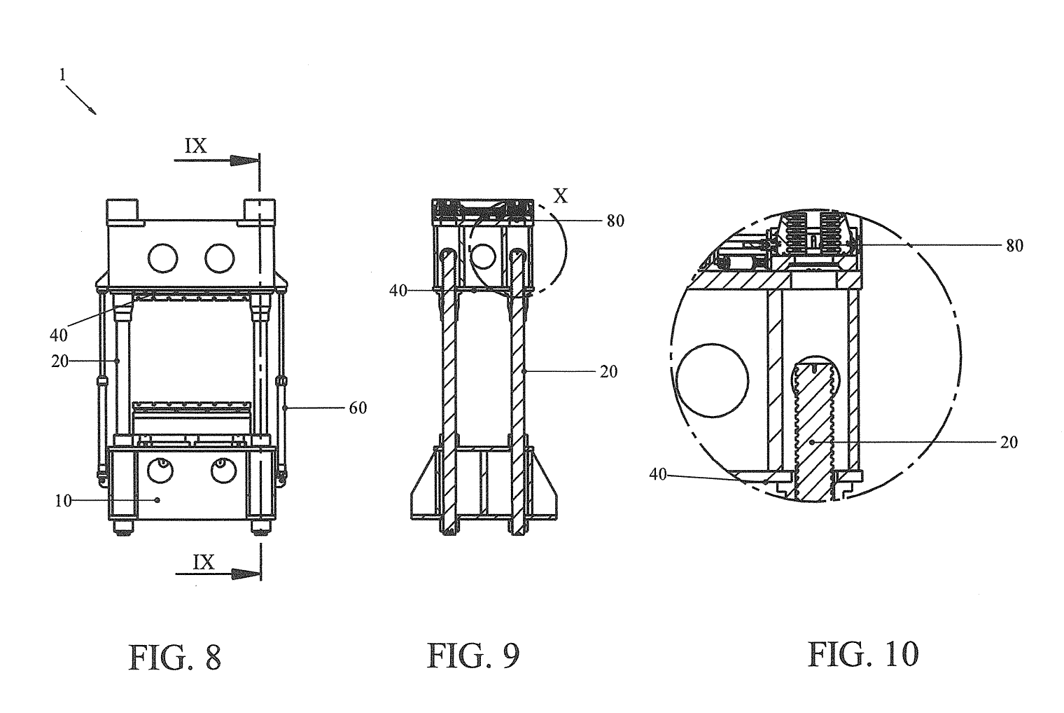

With reference to FIGS. 8, 9, 10, the second plane 40 connected to the risers 20 is blocked by means of a blocking apparatus 80, after a sliding with respect to the risers 20 to allow positioning the second plane 40 in a certain position by means of such second hydraulic cylinders 60.

Such first hydraulic cylinders 50 and such actuators 70 move the first plane 30 to allow opening or closing the mold and containing within a restricted tolerance threshold the parallelism between the first and the second plane 30, 40.

Each of the actuators 70 comprises a position sensor adapted to allow a controller to impress a force to allow each of such actuators 70 to reach a position adapted to contain within a restricted tolerance threshold the parallelism between the first and the second plane 30, 40. Such force is of an equal or opposite direction with respect to the direction of the force adapted to allow opening or closing the mold.

A first hydraulic circuit actuated by an hydraulic pump with constant flow-rate operates on a piston 51 of each hydraulic cylinder 50 (FIG. 4), a second hydraulic circuit actuated by a bag-type accumulator pre-charged with pressurized nitrogen permanently operates on a piston 71 of each actuator 70 (FIG. 7), a proportional valve allows modulating the force acting onto such piston 71.

A method for molding an ingot made of thermoplastic or thermosetting material by means of a press 1, comprises the following steps:
slowly opening the mold formed of the first half-mold fastened to the first plane 30 and possibly a second half-mold fastened to the second plane 40, by means of such first hydraulic cylinders 50 adapted to move the first plane 30;
quickly moving away the second plane 40, with respect to the first plane 30, by means of such second hydraulic cylinders 60;
Inserting the ingot to be molded inside the first half-mold;
quickly approaching the second plane 40 with respect to the first plane 30, by means of such second hydraulic cylinders 60;
Blocking the second plane 40, by means of such blocking apparatus 80;
slowly closing the mold, by means of such first hydraulic cylinders 50 adapted to move the first plane 30 and by means of such actuators 70 adapted to move the first plane 30 by applying a force to allow each of such actuators 70 to reach a position adapted to contain within a restricted tolerance threshold the parallelism between the first and the second plane 30, 40.

1. Press for molding an ingot made of thermoplastic or thermosetting material, comprising a basement integral with risers, a first and a second plane relatively sliding with respect to said risers, by means of first and second hydraulic cylinders, respectively adapted to allow opening and closing a mold formed of at least one first half-mold fastened to said first plane and a second half-mold fastened to said second plane and quickly increasing or reducing the relative distance between said first and said second plane and by means of actuators adapted to allow containing within a restricted tolerance threshold the parallelism between said first and said second plane, wherein said actuators are adapted to exert a force whose direction is equal to or opposite with respect to the direction of the force adapted to allow opening or closing said mold, and in that said first plane connected to said basement is moved by means of said first hydraulic cylinders and said actuators, said second plane connected to said risers is blocked by means of a blocking apparatus, after a sliding with respect to said risers to allow positioning said second plane in a certain position by means of said second hydraulic cylinders, said first hydraulic cylinders and said actuators adapted to move said first plane to allow opening or closing said mold and contain within a restricted tolerance threshold the parallelism between said first and said second plane.

2. Press according to claim 1, characterized in that each of said actuators comprises a position sensor adapted to allow a controller to impress a force to allow each of said actuators to reach a position adapted to contain within a restricted tolerance threshold the parallelism between said first and said second plane, said force having a direction equal to or opposite with respect to the direction of the force adapted to allow opening or closing said mold.

3. Press according to claim 2, characterized in that a first hydraulic circuit actuated by an hydraulic pump with constant flow-rate operates on a piston of each hydraulic cylinder, a second hydraulic circuit actuated by a bag-type accumulator pre-charged with pressurized nitrogen permanently operates on a piston of each actuator, and a proportional valve allows modulating the force acting onto said piston.

4. Method for molding an ingot made of thermoplastic or thermosetting material, by means of a press according to claim 1, comprising the following steps:
slowly opening the mold formed of said first half-mold fastened to said first plane and possibly a second half-mold fastened to said second plane, by means of said first hydraulic cylinders adapted to move said first plane;
quickly moving away said second plane, with respect to said first plane, by means of said second hydraulic cylinders;
inserting the ingot to be molded inside said first half-mold;
quickly approaching said second plane with respect to said first plane, by means of said second hydraulic cylinders;
blocking said second plane, by means of said blocking apparatus;
slowly closing the mold, by means of said first hydraulic cylinders adapted to move said first plane and by means of said actuators adapted to move said first plane by applying a force to allow each of said actuators to reach a position adapted to contain within a restricted tolerance threshold the parallelism between said first and said second plane.
